(19) United States
(12) Patent Application Publication
(10) Pub. No.: US 2012/0156443 A1
(43) Pub. Date: Jun. 21, 2012

(54) METHODS OF MULTI-SHOT INJECTION MOLDING AND METAL-PLATED SURFACE COATED POLYMERIC ARTICLES MADE THEREFROM

(76) Inventor: David Reeder, Grand Blanc, MI (US)

(21) Appl. No.: 13/326,770

(22) Filed: Dec. 15, 2011

Related U.S. Application Data
(60) Provisional application No. 61/423,443, filed on Dec. 15, 2010.

(51) Int. Cl. B23B 3/00; B05D 1/00

(52) U.S. Cl. 428/195.1; 427/322

(57) ABSTRACT

Molded metallized polymeric components are formed by methods of multi-shot injection molding of a first resin and a second resin, where the first resin forms a first polymer that is metal-platable and the second resin forms a second polymer that is resistant to metallization. The second resin defines one or more colored surface regions and may have one or more surface topcoats. The surface topcoat may be a transparent protective coating or a colored paint. Select regions corresponding to the metal-platable polymer surface are metallized. Molded decorative polymeric components formed from such methods are also provided.

### CROSS-REFERENCE TO RELATED APPLICATIONS

This application claims the benefit of U.S. Provisional Application No. 61/423,443, filed on Dec. 15, 2010. The entire disclosure of the above application is incorporated herein by reference.

### FIELD

The present disclosure relates to methods of multi-shot injection molding and metal plating polymeric articles having surface coating made therefrom.

### BACKGROUND

This section provides background information related to the present disclosure which is not necessarily prior art.

Plastic materials are used in a wide variety of applications. For example, many plastic components are used in vehicles, such as automobiles, to provide reduced weight, cost, and increased corrosion resistance advantages, among other benefits. Accordingly, plastic materials are often used as decorative components, for example, in detailing and trim features or as indicia of brands, logos, emblems, and the like. It should be noted that such decorative components are used in a wide variety of applications, such as consumer goods, appliances, reflector components, and the like, and are not limited to merely vehicles. Many such plastic components have multiple surface finishes in a single component, such as a combination of one or more colored surface finishes and one or more metallic surface finishes. Desirably these types of components are durable, yet have an aesthetically pleasing appearance.

Currently, when a decorative molded polymeric component requires two distinct different surface finishes, such as a metallic surface (e.g., chrome finish) and one or more colored surfaces, the components are molded and treated separately and then later assembled together. Thus, in conventional processes, a first component having a metallic surface finish is prepared and then joined with a second component having a colored surface in a sub-assembly process. By joining such distinct components together, the potential exists for gaps to occur along seams, edges, or joints, so that upon exposure to weather or other corrosive conditions, corrosion to the multi-surface plastic component may potentially occur. Because plastic decorative components may be used in applications where they are exposed to an external environment, including extreme weather conditions and exposure to UV radiation or corrosive agents, such plastic components may suffer from degradation or corrosion.

It would be desirable to develop a decorative molded polymeric component, particularly those having at least one metallized surface finish and at least one non-metallized surface finish, which can be produced in a streamlined process, while having greater robustness, quality aesthetics, durability, and corrosion resistance, for example.

### SUMMARY

This section provides a general summary of the disclosure, and is not a comprehensive disclosure of its full scope or all of its features.

In various aspects, the present disclosure provides methods for forming a molded metallized polymeric component. Such a molded metallized polymeric component may be a decorative component, for example. In certain variations, the present disclosure provides a method of forming a molded metallized polymeric component that comprises forming a molded component via multi-shot injection molding of a first resin and a second resin. The first resin forms a first polymer that is metal-platable. The second resin forms a second polymer that is resistant to metallization. Next, the method comprises metallizing one or more regions of a surface of the molded component to form one or more metallized regions over the first polymer. The method further comprises applying a surface coating to one or more regions defined by the second polymer to create one or more colored surface regions that are visually distinct from the one or more metallized regions, thereby forming the molded metallized polymeric component. In certain variations, the surface coating comprises a paint or a transparent ultraviolet radiation-stable coating.

In other aspects, the present teachings provide a molded metallized polymeric component. The component comprises one or more metallized surface regions formed on a first injection-molded polymer that is metal-platable and one or more colored surface regions corresponding to a second injection-molded polymer that is resistant to metallization. The first injection-molded polymer and the second injection-molded polymer are integrally formed with one another and at least a portion of the one or more metallized surface regions and the one or more colored surface regions are visible to an external environment.

In yet other aspects, the present disclosure also provides a decorative molded chrome-plated polymeric component that comprises a surface visible to an external environment comprising one or more chrome-plated regions disposed over an injection-molded metal-platable polymer and one or more colored painted regions disposed over a second injection-molded polymer that is resistant to metallization. The first and second injection-molded polymers are integrally formed during a multi-shot injection process. Further, the one or more colored painted regions are ultraviolet radiation stable.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a process flow diagram of a conventional process for forming a decorative plastic component having a metallized surface finish and colored regions applied by painting over the metallized surface finish;

FIG. 2 is a first conventional decorative plastic component having a surface with both metallized and colored regions formed by a conventional process in FIG. 1 (where the metallized regions are in the form of indicia of the letters “LOGO”), which is suffering from degradation and/or corrosion in one or more regions;

FIG. 3 is a process flow diagram for forming a decorative plastic component having a metallized surface finish and a paint-based surface coating forming colored regions according to certain aspects of the present teachings;

FIG. 4 shows a cross-sectional view of an embodiment of a decorative plastic component in the form of an exemplary grille for an automobile having a visible surface with both metallized and colored painted regions formed in accordance with the present teachings;

FIG. 5 shows a cross-sectional view of an alternative exemplary embodiment of a decorative plastic component in the form of an exemplary grille for an automobile having a visible surface with both metallized and colored painted regions formed in accordance with the present teachings;

FIGS. 6A-6B show an embodiment of a decorative plastic multi-polymeric component having a metallized surface finish and colored regions formed by a second metallization-resistant polymer according to certain aspects of the present teachings. FIG. 6A is a plan view of such a decorative component and FIG. 6B is a cross-sectional view taken along line B-B in FIG. 6A;

FIGS. 7A-7B show an alternative embodiment of a decorative plastic multi-polymeric component having a metallized surface finish and a surface coating disposed over a second metallization-resistant polymer to form the color region formed according with certain aspects of the present teachings.

FIG. 7A is a plan view of such a decorative component and FIG. 7B is a cross-sectional view taken along line B-B in FIG. 7A; and

FIG. 8 is an exemplary schematic showing a multi-shot polymer injection molding apparatus.

Corresponding reference numerals indicate corresponding parts throughout the several views of the drawings.

### DETAILED DESCRIPTION

Example embodiments will now be described more fully with reference to the accompanying drawings.

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. In addition, disclosure of ranges includes disclosure of all values included therein and further divided ranges (sub-ranges) within the entire range, including endpoints given for the ranges.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” and the like). As used herein, the term “and/or” includes any and all combinations of one or more of the associated listed items.

Although the terms first, second, third, and the like may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range, including endpoints given for the ranges.

The inventive technology pertains to an improved, streamlined process to make improved robust plastic components having both metallized and non-metallized colored surface regions. Further, the inventive technology includes the polymeric articles, such as decorative components, formed from such processes, as will be described in greater detail below. For a better understanding of the present teachings, a discussion of conventional processing techniques for forming plastic components (in particular those having a surface with at least one region defining a metallized surface and at least one region defining a non-metallized colored surface) is as follows.

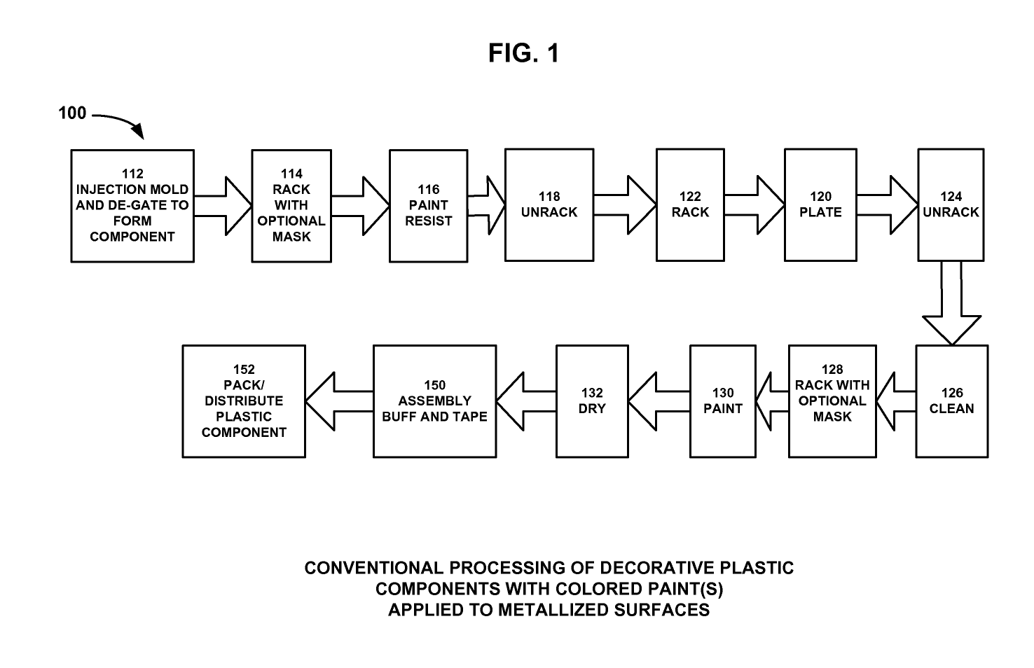

One type of an exemplary conventional process 100 that forms decorative plastic components (having both a metallized surface and a colored surface) is shown in FIG. 1, where a surface of the component is first metallized and then one or more colored paints are applied over the metallized surface. In such processes described herein, a simplified version of conventional processing steps is shown (omitting certain routine work-in-progress steps, where the component is stored to permit the completion of cooling, drying after processing, and the like). A polymeric component is formed by injection molding a polymer resin (optionally cross-linking the injection molded component) and de-gating it at 112. The polymeric component is then arranged on a rack 114 for further processing.

An optional mask can be applied to one or more surfaces of the polymeric component on the rack to protect the underlying regions at 114, so that any ensuing treatment processes are only applied to the unmasked regions of the polymeric component. In the conventional process, a resist material is applied to one or more surface regions of the polymeric component at 116. By painting a resist material on one or more regions of the polymeric component, the resist-coated surface regions are thus insulated during subsequent plating processes. Typically, after applying the resist at step 114, the polymeric component is then unracked from the racking at 118.

The second polymeric component is then arranged on an appropriate rack for plating at 122 (for example, designed to apply potential to the rack and components to conduct the plating process). The polymeric component on the rack is then subjected to a metal plating process 120, whereby one or more surfaces of the plastic component are treated to have a metallized surface appearance, such as a chrome finish. Notably, the areas coated with resist in step 116 are not metallized during the plating process. In conventional plating processes, the surface of the polymeric component to be metallized can be subjected to a direct wet chemistry process, where the surface to be plated is first etched, followed by optional electroless deposition of one or more layers and/or electroplating of one or more layers of metal-containing materials.

By way of non-limiting example, one particularly suitable exemplary metallization process includes a direct wet chemistry metallization process that includes wet etching, followed by an electroless plating process, and then a sequence of electroplating baths. Such a direct wet chemistry process can apply a chrome metal finish to the plastic surface. In one variation, etching is conducted by immersing the surface of the plastic component (or entire plastic component, for example, the rack holding the plastic component) in an etching solution comprising chromium (e.g., Cr (VI)) and sulfuric acid. After etching, the surface of the plastic component to be metallized (or the entire component itself) is subjected to an electroless plating process, which is an auto-catalytic process that applies a thin conductive metal layer (for example, a thin nickel-containing or copper-containing layer) onto the etched plastic surface, without the use of electric current.

After electroless deposition of such a conductive metal layer, the surface to be plated can be further subjected to wet chemistry metallic processing, which is well known in the art. One exemplary wet chemistry electroplating process to form a chrome-plated surface on the plastic component includes first electroplating one or more copper layers (Cu) over the electroless-deposited layer (comprising for example, a conductive metal like nickel and/or copper), followed by electroplating a nickel layer (Ni) and then a chromium (Cr) layer.

After plating, the polymeric component having one or more plated surfaces is then removed from the rack 124. Next, the polymeric component is cleaned 120. The cleaning process 120 may include removing the optionally included mask and/or resist material with appropriate removal processes and materials (such as solvents). In certain variations, the polymeric component may again be masked with a second distinct mask at 128 (which may cover the plated metallized regions or other regions to be shielded from subsequent application of surface coatings/paint to provide the desired decorative design).

In order to provide good adherence of paint over the metallized surface, one or more paints are applied to a surface of the polymeric component shortly after the metallizing process at 130, preferably within 24 hours or less of metallizing the surface. Thus, the surface of the polymeric component can be cleaned with an alcohol solvent at 126. Then, paint is applied to the surface regions of the polymeric component that are unmasked, for example to the non-metallized regions, at 130. The paint may be conventional exterior body paint. The polymeric component having the newly applied painted regions is dried at 132. Any optional masking applied at 128 can be removed after the drying process 132.

In conventional processing, such paints are usually applied multiple times to ensure good paint coverage and adhesion or to apply distinct colors to the surface. For example, in a conventional process, the cleaning, painting, and drying steps are repeated another three times. Then, the processed component can be finished and assembled 150. The assembly can be finished, for example, by buffing the finished surfaces (to remove any rough edges) and applying a tape or other adhesive to one or more surfaces, so that the assembly can be attached and coupled to a substrate in its final use. Finally, the assembled decorative component is packed for distribution 152.

Decorative polymeric parts formed by the conventional processes shown in FIG. 1 require a relatively large number of processing steps, which in addition to requiring greater material resources and energy, also require significant tooling and processing times. In process 100 where resist and paint are applied over a metallized surface on the injection-molded part, it can be difficult to process such a part successfully, both due to the short/tight process window (to apply paint within a short time of metallization of the surface) and to control the environment during application of paint, including carefully controlling temperature and humidity, which can have a significant impact on paint adhesion to the underlying metallized surface.

Furthermore, it has been observed that decorative components formed by a process where paint is applied over metal-plated surfaces formed by the process 100 of FIG. 1 have the potential to suffer from environmental degradation, solvent attack, peeling, and/or delamination issues. For example, in an automotive application, a decorative component of the vehicle may be coupled to a new manufactured vehicle and then subjected to final processing and finishing steps, often including applying a water-repellant material over the entire external surface of a vehicle, such as the commercially available RainX™ material. Such a material usually contains solvents and thus, has the ability to penetrate any seams, joints, or edges in the decorative plastic component providing the potential for corrosive agents to degrade the decorative surfaces. Further, when exposed to environmental conditions, corrosive elements may penetrate the decorative component's edges, seams, or joints, which likewise have the potential to cause unacceptable degradation of one or more surfaces of the decorative component.

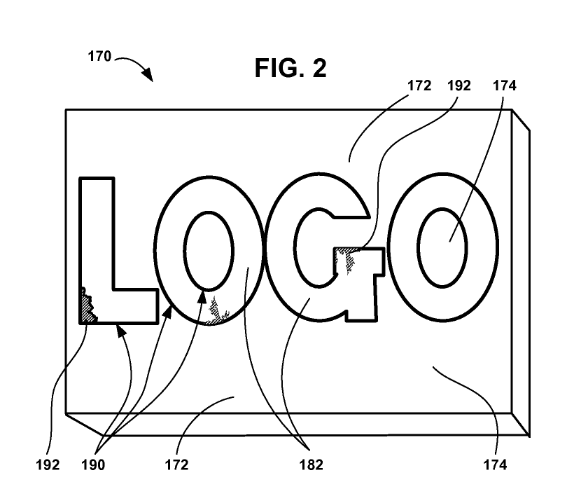

Such corrosive attack or degradation is shown in the exemplary schematic of decorative plastic component in FIG. 2. Decorative components formed via the processes discussed in conjunction with FIG. 1 and as shown in the representative design of FIG. 2, where paint is applied over a metallized surface, potentially suffer from corrosive attack or delamination. An exemplary decorative plastic component 170 comprises a major surface 172 having one or more regions 174 with a first surface finish, such as a metallized surface finish (e.g., formed by plating).

As appreciated by the discussion above, such a metallized finish can be applied to cover the entire major surface 172 or may be applied in discrete or distinct surface regions. The major surface 172 also has a second surface finish 182 formed in one or more regions (here in the regions designated “LOGO”). The second surface finish 182 can be applied over the first metallized surface finish 174 by masking and application of resist materials, so that only the regions where the second surface finish 182 is to be formed are contacted with paint during the painting process. The second surface finish 182 may be a colored surface formed by applying one or more layers of paint over the metallized surface finish 174. Further, multiple distinct paint colors can be applied to form the second surface finish 182. The second surface finish 182 may include a plurality of different paint colors, as well.

Several edges 190 are formed at the interfaces between the first metallized surface finish 174 and the second painted surface finish 182 along the surface 172. As shown in FIG. 2, certain regions of the edges 190 (between the first and second surface finishes 174, 182) can suffer from degradation and/or corrosive attack (shown as peeling/delaminated regions 192). Such degradation may occur at any location, especially at joints, seams, or edges, but is not limited to the embodiment shown here. The decorative component 170 is merely exemplary and may have far more complex shapes and designs; therefore such corrosive attack may occur in a variety of regions corresponding to the complex design.

In view of some of the potential shortcomings of the conventional processing techniques for forming decorative plastic components having at least two distinct surface finishes (e.g., a painted surface finish and a metallized surface finish), the present teachings provide a streamlined and more efficient process for forming such decorative components having improved robustness and durability, while exhibiting diminished susceptibility to degradation or corrosive attack. In certain variations, the improved processes eliminate the need for separate formation processes and separate tooling for forming plastic components with both metallized and non-metallized surface finishes, and can potentially eliminate the need for masks, resists, racks, and the like.

For example, in various aspects, processes of the present teachings eliminate the need for application of resist and masking prior to metallization (e.g., steps 114-118 of FIG. 1). In certain variations, no painting step is required whatsoever, thus also eliminating steps 128-132 of FIG. 1). Additionally, decorative components formed from the various processes of the present disclosure have reduced susceptibility to chemical attack and can eliminate potential peeling and delamination of the metallized finish or alternatively, the colored surface finish applied to a metallized surface finish.

In various aspects, the present disclosure provides a polymeric component, such as a decorative molded polymeric component, comprising a surface having one or more metallized surface regions and one or more non-metallized colored regions. By “metallized” it is meant that the surface of the plastic has a metallic surface finish or metallic appearance and in preferred aspects, comprises a metallic material containing one or more metals or metal alloys. A surface having one or more of such metallized regions includes an entire major surface of the plastic component being covered with a metallic material (so that a single metallized region covers an entire surface) or may include discrete and distinct regions (either contiguous or non-contiguous regions) of metallic material along the surface. A “non-metallized” surface region is one that has minimal metal present or that is substantially free of metal, so that the surface region does not appear to have a metallic surface finish or metallic appearance, in contrast to the metallized surface regions. In certain preferred aspects, the non-metallized surface region has a colored surface finish (or multiple colored surface finishes) that may include coverage of an entire major surface, but also includes partial surface coverage, including both contiguous and non-contiguous colored surface regions.

In various embodiments, metallized surface regions are formed over a first polymer that is metallizable, such as a metal-platable polymer. In yet other aspects, the non-metallized surface regions are formed and defined by a polymer that is resistant to metallization, in particular resistant to metal deposition during a metallization process. Metallization can include deposition of a metal selected from the group of non-limiting metals: copper, iron, zinc, cobalt, palladium, chromium, magnesium, manganese, cadmium, niobium, molybdenum, gold, palladium, nickel, tungsten, and combinations thereof. As will be discussed in greater detail below, in certain embodiments, the metallized surface region has a chrome appearance and includes deposition of metals selected from the group consisting of: nickel, copper, chromium, and combinations thereof. In addition to deposition of metallic elements, a non-metallic element can be co-deposited with the metal (for example phosphorous or boron). In certain aspects, the metallization process is a metal-plating process, such as a preferred direct wet metallization chemistry process. The metallization can be carried out by first etching the surface of the polymeric component to be metallized followed by immersion in a bath of a metallization liquid composition (solution, dispersion, gel, emulsion, and the like) with or without an electrical current.

In various embodiments, the molded polymeric component also comprises a surface that has one or more colored surface regions defined by a second polymer. A “colored” surface finish includes exhibiting a color in the visible wavelength range, which has a degree of contrast in opacity and/or color spectrum as compared to other surface regions (particularly visually distinct from the metallized surface regions). In certain aspects, a colored surface region may correspond to non-metallized regions, so that the colored regions are substantially free of metallization. As noted above, a colored region that is substantially free (or entirely free of) metallization does not have a metallic surface finish to an observer of the surface. The colored region(s) can optionally cover an entire major surface of the molded component or alternatively, may cover discrete and distinct regions along the surface, for example, to define one or more visible features or patterns. In certain embodiments, the decorative molded polymeric component thus comprises a colored second polymer that defines at least one colored region of the decorative component's surface so that it has a colored surface finish, where the polymer forming the colored regions is resistant to metallization, like metal-plating, and therefore is not metallized. In other variations, the colored regions may have multiple colors, for example by using multiple distinct colored polymers to define two or more distinct colored surface finishes corresponding to multiple non-metallized surface regions.

In yet other aspects, one or more regions corresponding to the second polymer may have a surface coating applied thereon. By way of example, such a surface coating may be a colored paint or a protective, transparent, ultraviolet radiation stable overcoat that protects the underlying second polymer. In other variations, a surface coating may comprise both a colored paint (e.g., a colored paint susceptible to degradation when exposed to ultraviolet radiation) and a protective, transparent, ultraviolet radiation stable overcoat that protects the underlying colored paint. Such transparent surface coatings may be tinted or have other optic effects, so long as at least a portion of the underlying metallized region(s) and/or colored region(s) are visible. In various aspects, the surface coating is stable in the presence of ultraviolet (UV) electromagnetic waves.

Optionally, the decorative molded polymeric component may comprise one or more protective surface coating layers formed over the surface of the decorative component defining both the metallized surface finish and the colored surface finish. Such a protective surface coating layer is disposed adjacent to at least one of the first or second polymers and can desirably protect the underlying first and/or second polymers from exposure to an external environment. In certain aspects, the protective surface coating may cover or encapsulate one or more edges or interfaces defined between the first or second polymers or between the metallized and colored surface finishes. Preferably, at least a portion of one or more metallized regions and at least a portion of the one or more colored regions are visible to an external environment.

In certain aspects, multiple surface coatings may be used to form the one or more surface finishes. For example, two or more distinct paints can be used to form two distinct colored surface finishes. Alternatively, one or more colored paints may be used concurrently with a protective transparent ultraviolet radiation-stable overcoat.

In various embodiments, the first polymer and the second polymer of the polymeric component are formed by injection molding a first resin and a second resin. In certain preferred aspects, the polymeric component is formed via a multi-shot injection molding process that will be described in greater detail below. A “resin” as used herein is an organic material, typically of high molecular weight, such as a polymer, which may be a polymer precursor, for example, monomers and/or oligomers capable of subsequent cross-linking or further reaction, or may comprise a cross-linked or cured polymer. In certain aspects, resins exhibit a tendency to flow when subjected to stress, thus, may be a liquid or viscous polymer or polymer precursor that is capable of being injected into a polymer injection mold cavity. In certain variations, a curing process transforms the resin into a polymer by a cross-linking process.

Thus, in various aspects, the first polymer and the second polymer are integrally formed and thus create a single, unitary body, for example, formed by multi-shot injection molding of the first resin and second resin in the same process, so that they are bonded or fused together. Thus, after multi-shot injection molding formation of the first and second polymers, a multi-polymeric component is formed containing both the first and second polymers, which has one or more metallized surface regions and one or more colored surface regions. The molded multi-polymeric component optionally has at least a portion of the one or more metallized surface regions and at least a portion of the one or more colored surface regions visible to an external environment, so that it is particularly suitable as a decorative component.

In certain embodiments, the molded polymeric component optionally comprises a plurality of distinct polymers. The plurality of distinct polymers may form distinct surface regions that may be mutually exclusive and non-overlapping or alternatively may completely or partially overlap. For example, the present disclosure contemplates a plurality of first polymers that can be metallized and a plurality of second polymers that are resistant to metallization and may have different colors or can be covered with a surface coating, such as a colored paint. Further, in certain variations, the molded polymeric component optionally comprises a third or multiple other multi-shot injection-molded polymers.

Thus, in preferred variations, a molded decorative component of the present teachings is formed by an injection molding process, which is typically an automatic process where a hydraulic press can be used (e.g., a hydraulic press that is generally horizontally-oriented), where the molding resin(s) is screw injected into one or more closed mold cavities (optionally having one or more cores disposed therein) via a sprue and a system of gates and runners. Pressure is then applied at the appropriate temperature to solidify the part. The mold is opened for part ejection and removal, the mold is closed, and the next charge is injected by the screw.

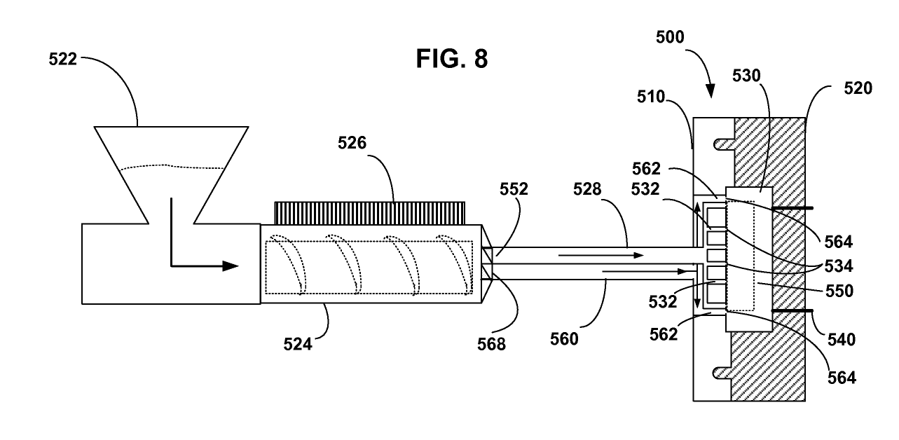

By way of non-limiting example, an exemplary simplified injection molding process configured for multi-shot injection molding is shown in FIG. 8. A mold assembly 500 comprises two primary components, the injection mold (A plate, 510) and the ejector mold (B plate, 520). Plastic resin (usually fed to a hopper 522 as pellets) enters a screw conveyor 524, which includes a heater 526 that applies heat to the resin material. The resin passes through the screw conveyor 524 to a first sprue 528 to apply heat to the resin while it is pressurized and fed via screw conveyor 524. The resin enters a cavity 530 in the mold 500 through the first sprue 528. As shown, sprue 528 directs the molten plastic resin to a plurality of open channels or runners 532 that are formed (e.g., by machining) into the faces of the A and B plates 510, 520 and lead to the cavity 530 defined by the mold assembly 500. The molten resin flows through the first runners 532 and enters one or more specialized gates 534 to enter into the cavity 530 to form the desired part having a shape defined by the cavity.

The mold assembly 500 can be heated and/or cooled in different regions through external control systems (with heat transfer channels or heating elements built into the mold and/or ejector, not shown in FIG. 8). The mold assembly 500 is usually designed so that the molded part reliably remains on the ejector side (B plate, 520) of the mold assembly 500 when it opens, and draws the portions of first runners 532 and the sprue 528 filled with resin out of the plate A side 510. The molded component is then readily ejected from the plate B 520 side. The molded component is removed from the runner system by ejection from the mold assembly 500, for example, by ejection from plate B side 520. Ejector pins 540, also known as knockout pin, include one or more circular pins placed in either half of the mold assembly (usually the ejector half 520), which pushes the finished molded product, or runner system out of the mold assembly 500.

Two-shot or multi-shot molds are designed to “overmold” within a single molding cycle and can be processed on specialized injection molding machines having two or more independent injection units. Multi-shot injection molding includes separate injection molding processes performed multiple times. For example, in a first step, a first resin is molded into a first cavity or first region or volume of a cavity to form a molded article having a basic shape. Then, a second material is injection-molded into the remaining open spaces (for example, defining a second cavity or void region within the first cavity around the first region). The void space is then filled during the second injection step with a distinct resin material and thus forms a second molded article comprising both the first molded resin material and the second molded resin material integrally formed into a single molded component. In certain variations, the first and second cavities are substantially separated from one another (independent cavities defined in the mold assembly); although such separate cavities may have some interconnection points or openings between them to facilitate interconnection, fusing, or bonding of the polymeric parts together.

In various aspects, a molded decorative component of the present teachings can be formed by multiple-shot injection molding. “Multiple-shot injection molding” refers to an injection molding process for forming a molded polymeric article formed by first forming a predetermined shape by a primary molding of a first resin composition to give a first molded portion of the article, and integrally molding at least one other resin composition in contact with the first resin composition. Integral molding refers to forming a first molded article comprising a first molded material from a first molding process that is combined with a second molding process that adds one or more supplemental molded materials in contact with the first molded article thereto, thus forming an integral, monolithic second molded article comprising both the first molded material and the supplemental molded material(s) molded and interconnected together.

As shown in the simplified schematic of FIG. 8, a multi-shot injection system includes a first sprue 528 that leads to a plurality of first channels/runners 532 and plurality of first gates 534 into the mold cavity 530. When the first resin is injected into the mold cavity 530, it may only occupy a first portion of the cavity (see for example, the area or volume designated 550 in the cavity 530). The first sprue 528, the first runners 532, or first gates 534 may optionally comprise one or more valves or other means to prevent resin flow (shown in FIG. 8 as a valve 552 in sprue 528). As appreciated by those of skill in the art, the placement and number of sprues, runners, gates, and valves is not limited to exemplary embodiment shown here. A second sprue 560 leads to a plurality of second runners 562 that end in a plurality of second gates 564, which open to mold cavity 530. Different materials can be fed to the same hopper 522 and screw feeder assembly 524 in this molding apparatus configuration, although in alternative embodiments, the feeding systems may be independent from one another (including independent hoppers, screw feeders, sprues, and the like). During the process of feeding of the first resin to the mold cavity 530, first valve 552 in first sprue 528 is open, while a second valve 568 in the second sprue 560 is closed to permit the first resin to flow into the first runners and first gates 532, 534. Then, a first valve 552 is closed and the second valve 568 is opened. A second resin can then be fed through the open valve 568 to the mold cavity 530 via sprue 560, second runners 562, and second gates 564. The second resin enters the remaining void regions of the cavity 530 (for example, in the unoccupied regions surrounding area 550) and thus is over-molded to the first resin material to form an integrally molded multi-polymer component.

The most simplified multi-shot injection process is a “two-shot” injection molding for two distinct resins; however, injection of multiple resins in excess of two is also contemplated. Further, integral molding of the same or other resin compositions can also be carried out in contact with a previously molded composition of the article to build upon and create yet another article.

The final multi-shot molded article thus formed is preferably subjected to cross-linking or curing (for example, while still contained in the injection mold assembly). An article or component formed by the multi-shot polymer injection techniques taught in the present disclosure preferably has at least two distinct surface regions, each having different metallization characteristics, so that the component can be simultaneously exposed to metallizing conditions, while having different surface finishes as a result. For example, a multi-shot molded article can be exposed, submerged or partially dipped into a bath of metallization liquid composition. Such metallizing can include optionally subjecting the multi-polymeric component to etching, a catalyst, or other treatments as a pretreatment for metallizing (one or more times) of the final molded article, if desired, to form a metallized region containing a metal material. Thereafter, only one of the two distinct surface regions of the multi-polymeric component has a metallized surface finish applied, while the other of the two surface regions is substantially free of metallization.

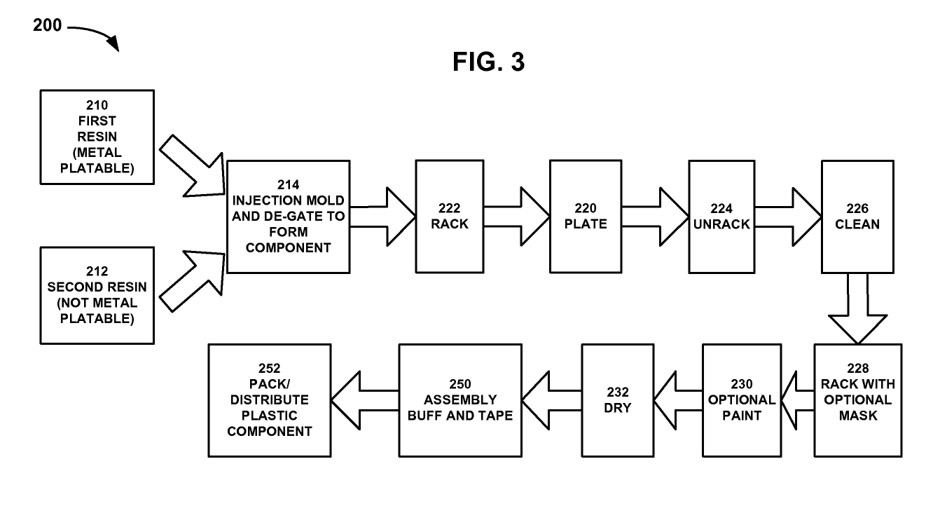

Thus, in various aspects, the present disclosure provides methods for forming a decorative molded polymeric component. For example, as shown in FIG. 3, in certain embodiments, the methods of the present teachings include injection molding a first metal-platable resin (that forms a first metal platable polymer) with a second resin (which preferably forms a second polymer that is resistant to metallization, especially resistant to deposition of metals during metal-plating), in a multi-shot injection molding process to form a molded piece having a first polymer with a metal-platable surface region and a second polymer that either itself defines a colored surface region or alternatively can adhere to one or more surface coatings to create the colored surface region(s).

As discussed above, typically in multi-shot polymer injection molding, a first resin is injected into a first gate of a mold that defines a first cavity (or multiple first cavities). The first resin is injected to fill the first cavity of the mold. The mold also defines a second cavity (or multiple second cavities). Then, a second resin is injected into the mold. In certain aspects, the second cavity is designed to contact the first cavity in specific regions, so that the second resin is overmolded onto the first resin occupying the first cavity. The first and second cavities may optionally be designed to have one or more locking features to secure the first polymer formed from the first resin to the second polymer formed from the second resin.

In certain preferred aspects, the resin compositions that are used in the present methods can have different melting or transition point temperatures (e.g., in the case of polymers, such a melt temperature may reflect a glass transition point temperature or a softening temperature, for example, a temperature at which the polymer transforms from a crystalline or semi-crystalline structure to an amorphous structure). It is desirable to mold the second resin composition at a temperature that is lower than the melt temperature of the first molded composition. During molding, partial softening and/or melting at the areas where the two materials are in contact can promote adherence and bonding of the two materials. In certain variations, the contacting surfaces of the molded compositions can be designed with features to improve the bond strength between the contacting surfaces of the integrally molded materials. For example, one molded material surface can have one or more channels, locking features, ridges, pits, buttons, holes, pores, tunnels and the like, including any structures or bonding known to those in the injection molding arts.

In certain aspects, the first resin has a higher melt flow rate and/or melt flow index than a second resin, which is injected and fills the first cavity of the mold prior to introduction of the second resin. The second resin has a lower melt flow rate and/or melt flow index than the first resin, which is injected after the first resin into the mold. In this regard, the second resin will be molded over the first resin (so that they are integral and coupled with one another by interlocking or bonding together), but is injected at a lower temperature that will not melt or otherwise undesirably physically distort the shape of the first piece formed by the first resin having the higher melt flow rate and/or melt flow index.

Therefore, in certain variations, the molding of separate compositions can be done at different melt temperatures or different mold injection temperatures. Preferably, the difference of melt temperatures of the first and second resins or different in mold injection temperatures is at least about 25° Celsius. The mold temperature may be the same for the one, two, or more mold cavities, or it may be different.

In one embodiment, a first molded article is molded of a first resin composition having a first melting or maximum injection temperature, and the later molding (of the second and/or third resin compositions) is made at an injection temperature at least 50° Celsius lower than that melting temperature or injection temperature of the first resin composition of the first molded article. In other embodiments, the first molding injection temperature or first resin melting point is greater than or equal to about 55° C.; optionally greater than or equal to about 60° C.; optionally greater than or equal to about 70° C.; optionally greater than or equal to about 80° C.; optionally greater than or equal to about 90° C.; optionally greater than or equal to about 100° C.; optionally greater than or equal to about 115° C.; optionally greater than or equal to about 125° C.; optionally greater than or equal to about 150° C.; and in certain aspects, optionally greater than or equal to about 175° C. higher than that melting temperature or injection temperature of the second resin composition that forms the second molded article.

In other variations, viscosity can be used to determine flow properties (other than molecular weight and melting point/transition temperatures). For example, the melt flow index (MFI) is related to molecular weight of the polymer and measures how much a resin material flows through an orifice over a given time period under a constant pressure. More specifically MFI is defined as the mass of polymer (e.g., resin), in grams, flowing in ten minutes through a capillary of a specific diameter and length by a pressure applied via prescribed alternative gravimetric weights for different prescribed temperatures. The method is described in the similar standards ASTM D1238 (Standard Test Method for Melt Flow Rates of Thermoplastics by Extrusion Plastometer) and ISO 1133 (Plastics—Determination of the melt mass-flow rate (MFR) and the melt volume-flow rate (MVR) of thermoplastics).

MFR is similar to MFI and is an indirect measure of molecular weight, with high melt flow rate corresponding to low molecular weight. At the same time, melt flow rate is a measure of the ability of the material's melt to flow under pressure. Melt flow rate is inversely proportional to viscosity of the melt at test conditions, although viscosity for any such material depends on the applied force. Generally, lower viscosity resins require lower temperatures during injection molding and higher viscosity having the highest molding temperatures.

Accordingly, in certain embodiments, the first resin composition can have a melt flow rate of greater than or equal to about 10 g/10 minutes to less than or equal to about 30 g/10 minutes; optionally from greater than or equal to about 12 g/10 minutes to less than or equal to about 20 g/10 minutes; optionally from greater than or equal to about 12 g/10 minutes to less than or equal to about 15 g/10 minutes, as measured under standard temperature and applied force conditions (e.g., per ASTM D1238). Similarly, in certain embodiments, the second resin composition has a melt flow rate of greater than or equal to about 2 to less than or equal to about 10 g/10 minutes; optionally greater than or equal to about 3 to less than or equal to about 7 g/10 minutes; optionally greater than or equal to about 3 to less than or equal to about 5 g/10 minutes as measured under standard temperature and applied force conditions (e.g., per ASTM D1238).

Once the molded component is pre-formed via multi-shot injection molding, in certain preferred variations, cross-linking of the resins is performed to facilitate bonding of the first resin material to the second resin material and to form the first polymer and second polymer therefrom. In certain preferred aspects, cross-linking occurs by heating the first and second resins during the injection molding process or heating the mold plates while the resins are being held in the mold assembly (prior to de-gating the component).

Cross-linking can also occur by applying actinic radiation, such as X-rays, gamma rays, ultraviolet light, visible light or alternatively, electron beam radiation, also known as e-beam. Ultra-violet radiation (UV) typically includes radiation at a wavelength or a plurality of wavelengths in the range of about 170 nm to 400 nm. Ionizing radiation typically includes means high energy radiation capable of generating ions and includes electron beam radiation, gamma rays and x-rays. E-beam means ionizing radiation of an electron beam generated by Van de Graff generator, electron-accelerator, x-ray, or the like. Such radioactive cross-linking can occur at elevated temperature such as when both first and second resin materials are placed together at above the melting point of either component or at room temperature or at any temperature there between.

In accordance with preferred aspects of the present teachings, the first resin forms a metal-platable polymer, as where the second resin is selected so that it forms a second polymer that is resistant to metallization and preferably defines a colored non-metallized surface finish. The second polymer optionally itself defines colored surface region(s) or alternatively can adhere to one or more surface coatings to create the colored surface region(s). The specific polymeric/resin materials will be in more detail below. It should be further noted that multiple resins, whether selected to be metal-platable resin or resins resistant to metal plating, can be injected sequentially into the mold to form a component having various distinct surface finishes or to provide protective layers in certain variations. In other words the number of resins is not limited to a single first resin and a single second resin, but rather may include a plurality of resins, including a plurality of distinct first resins, a plurality of distinct second resins, and a plurality of third resins.

FIG. 3 shows an exemplary process 200 for forming a polymeric decorative component via multi-shot injection in accordance with certain aspects of the present teachings. The first resin is metal platable 210 and is introduced into the injection mold. Then, the second non-metallizable resin 212 is introduced to the same mold. The multi-shot injection molding process of the first and second resins occurs at step 214.

After injection molding and preferably cross-linking, the first and second resins in the mold 210, 212 form a first polymer and a second polymer. Then, the integrally formed multi-polymer component is de-gated and removed from the injection mold 214. Then, the multi-polymer component is racked 222 and metallized by plating at 224. It should be understood that while the metallization is specified to be a plating process including electroless or electrolytic deposition, it may also be conducted by any known technique.

In preferred aspects, metallization occurs predominantly or exclusively on a surface of one polymer composition (the first metal-platable polymer formed from the first metal-platable resin 210), while is substantially absent from the surface of another polymer composition (the second polymer formed from the second resin that is resistant to metallization). In another aspect, contiguous metallization is found on a portion of a surface of the polymeric component along the metallizable polymeric composition and hardly or not at all on the surface of another composition resistant to metallization.

For example, after racking at 222, the multi-polymer molded component may optionally be plated with one or more metals in an electroless bath and electroplating deposition bath 220, such as those conventional plating techniques described above. By way of example, one particularly suitable metallization process includes etching, followed by an electroless plating process, and then a wet chemistry metallization bath to apply a chrome metal finish to the plastic surface.

By further way of example, one particularly suitable metallization process includes wet etching, followed by an electroless plating process, and then a wet chemistry metallization bath to apply a chrome metal finish to the plastic surface, as described previously above. In one variation, etching is conducted by immersing the surface (or entire plastic component) in an etching solution comprising chromium (e.g., Cr (VI)) and sulfuric acid. While not limiting the present teachings to any particular theory, it is theorized that wet etching increases surface roughness and surface area of the metal-platable first polymer. For example, the etching solution is believed to remove or react with some of the butyl diene groups at the surface of the first polymer. Meanwhile, the metallization-resistant polymer does not experience such physical changes on the surface. Such an etching step altering the surface properties of the surface of the metal-platable first polymer enhances deposition of metal-containing material(s) thereto, while the second polymer remains largely resistant to any metallization processes.

For example, in one embodiment, after etching, the surface of the plastic component to be metallized (or the entire component itself) is subjected to an electroless plating process, which is an auto-catalytic process that includes applying a thin conductive metal layer onto the etched plastic surface without the use of electric current. In certain aspects, the electroless bath may contain and deposit metal elements selected from the group consisting of: nickel (Ni), copper (Cu), and combinations thereof. In addition to deposition of such metallic elements, a non-metallic element can be co-deposited with the metal (for example phosphorous (P) or boron (B)). In one embodiment, such an electroless bath may comprise a medium phosphorus electroless nickel bath (comprising about 7% phosphorus (P)).

After electroless deposition of such a conductive metal layer, the surface to be plated can be further subjected to wet chemistry processing, which is well known in the art. One exemplary wet chemistry electroplating process that forms a chrome-plated surface on the plastic component, includes electroplating first a copper (Cu) layer over the electroless-deposited layer comprising phosphorus and nickel, followed by electroplating a nickel layer (Ni) and then a chromium (Cr) layer. In such a wet chemistry process, the following non-limiting steps can be used to metallize the surface of the plastic component (after etching and electro-less deposition) via contact with or preferably immersion in baths or plating solutions. For example, several distinct plated layers of copper (Cu) metal can be applied sequentially, followed by acid activation. Then, several nickel (Ni)-plated layers can be applied over these Cu plated layers. The final Ni-plated layer can then be activated by a Cr bath, where a Cr plate is deposited. This Cr plating is then followed by a caustic stripping and then an acid stripping process to form a metallic region on the polymer surface having a chrome appearance.

A metallization process can also include a variety of metallization-promoting ingredients, which are known in the art to achieve metallization faster, achieve improved adherence or thickness, or so that metallization can be conducted at lower temperatures, and the like. Metallization-promoting ingredients can include salts, fillers, crystals, polymers, hydrophilic polymers, amide polymers, clays, minerals, calcium carbonate, and amide polymers, by way of non-limiting example.

Therefore, the molded multi-polymer piece is metal plated in one or more surface regions corresponding to the first metal-platable polymer to create a metallized surface. After the plating process 220, the surfaces of the regions comprising the metal-platable polymer have a metallized surface finish, as where at least one colored surface remains in regions corresponding to the second polymer resistant to metallization, which remains intact having a colored surface finish that has minimal metal applied thereto. The multi-polymer molded component is the un-racked at 224.

As shown in FIG. 3, the formation process includes an optional step of applying a surface coating in the form of a paint at 230. Thus, a preparatory series of steps may be conducted, including cleaning the surface to be coated 226, racking the decorative component and optionally applying a second mask (for example, to shield the metallized areas from surface coating/paint application) 228. After painting 230, the decorative component is dried 232. As noted above, the surface coating process may in actuality include multiple serial application steps to apply a paint and/or protective surface coating, thus requiring any or all of steps 226-232 to potentially be repeated numerous times.

In embodiments where the multi-shot multi-polymer plastic decorative component has a second polymer that forms the desired colored surface finish and is selected to be an ultraviolet stable polymer, additional steps (corresponding to steps 226-232) for applying a surface coating are not necessary. Then, the multi-polymer plastic decorative component can be finished and assembled 250, for example, by buffing the finished surfaces, which may involve buffing rough edges occurring due to the metallization process, and optionally applying an adhesive to a surface of the multi-polymer component that will be coupled to a substrate in the final application or use of the component. Finally, the assembled multi-polymer molded component is packed for distribution at 252.

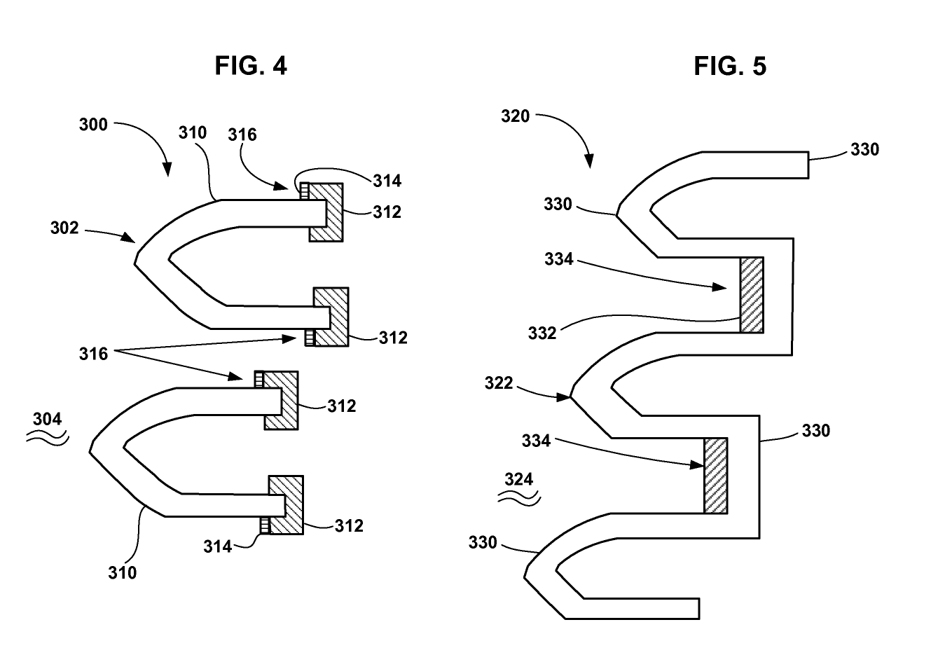

FIGS. 4 and 5 show cross-sectional views of two exemplary decorative plastic components in the form of two different decorative grille components for an automobile, each having a visible surface with both metallized and colored surface regions applied in accordance with exemplary processes of the present teachings.

In FIG. 4, an exemplary multi-polymer plastic decorative component in the form of an exemplary automobile grille 300 is formed by the multi-shot injection process described above in the context of FIG. 3. The multi-polymer automobile grille 300 has a surface 302 that is visible to an external environment 304. The multi-polymer automobile grille 300 includes a metal-platable polymer 310, which has a chrome-plated finish. The automobile grille 300 also has a second polymer 312 that is resistant to metallization (and further is preferably substantially free of any metal-plating). In the grille 300 of FIG. 4, a surface coating 314 is disposed over the second polymer 312 in visible surface regions. The surface coating 314 may be a paint or a transparent protective coating, as discussed above. Thus, the surface coating 314 defines colored surface regions 316 distinct from the chrome-plated surface finish of the first metal-platable polymer 310 in vertical rib areas of the grille 300.

In an alternative embodiment of FIG. 5, an exemplary multi-polymer plastic decorative component in the form of an exemplary automobile grille 320 is formed by the multi-shot injection process in accordance with certain aspects of the present teachings. The multi-polymer automobile grille 320 has a visible surface 322 that is exposed to an external environment 324. The multi-polymer automobile grille 320 includes a metal-platable polymer 330, which has a chrome-plated finish. The automobile grille 320 also has a second polymer 332 that is resistant to metallization (and further is preferably substantially free of any metal-plating).

In the grille 320 of FIG. 5, the second polymer 332 has a colored surface finish and is preferably UV-stable, so that a surface coating is not required or applied. Optionally, a surface coating (not shown, but like those discussed above) can be disposed over one or more regions of the second polymer 332 for protection or creating distinct colored surface finishes. Thus, in FIG. 5, the grille 320 has one or more colored surface regions 334 defined by the second polymer 332 distinct from the chrome-plated surface finish of the first metal-platable polymer 310 in vertical rib areas along the visible surface 322.

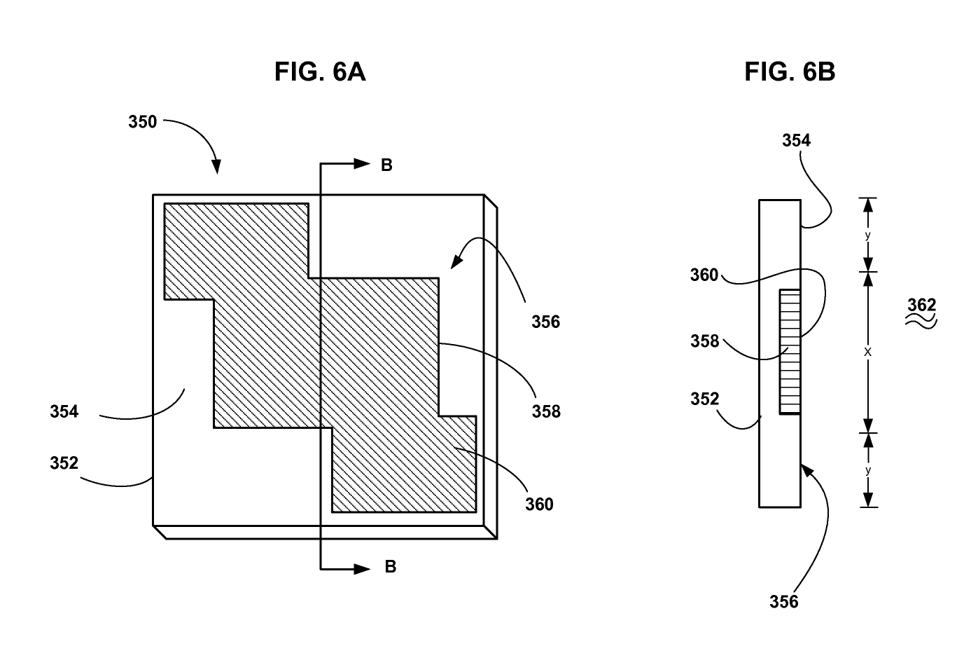

In yet another embodiment of the present teachings, a multi-polymer plastic decorative component 350 formed in accordance with certain aspects of the present teachings, is set forth in FIGS. 6A-B. The polymeric component 350 includes a metal-platable polymer 352 defining at least one region 354 of a surface 356 of the component 350 that is metallized. The multi-polymer plastic decorative component 350 also has a colored polymer 358 that defines at least one colored surface region 360 (designated by “x” in FIG. 6B) of surface 356, where the colored polymer 358 forming the colored polymer surface region 360 is resistant to metallization (and further is preferably substantially free of metal-plating). The metallized surface region 354 may be seen from a viewing perspective (designated by “y” regions) in the surrounding environment 362 adjacent to the colored surface region 360 (“x” regions).

Together, the first metal-platable polymer 352 and the colored polymer 358 define the surface 356 of the component that can be viewed from the surrounding external environment 362. As shown in the present embodiment, the first metal-platable polymer 352 and the colored polymer 358 are injection molded to be substantially flush with one another to form surface 356. As appreciated by those of skill in the art, such an embodiment is exemplary, because the first metal-platable polymer 352 and second colored polymer 356 can be multi-shot injected to form any number of different configurations, thus forming any number of designs by respective locations of metallized surface 354 and colored surface region 360.

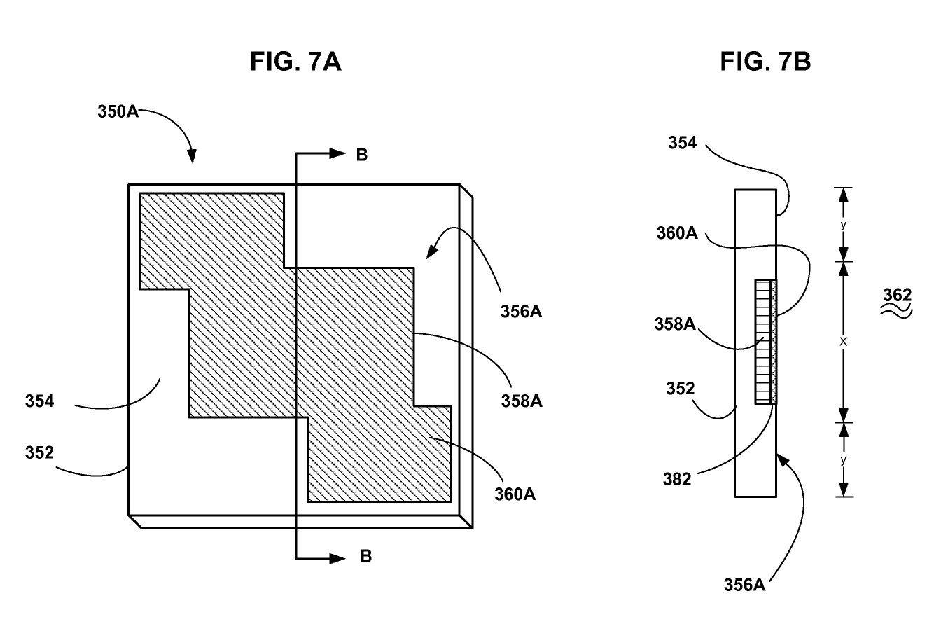

In a similar alternative embodiment of the present teachings, a multi-polymer plastic decorative component 350A of FIGS. 7A-7B is formed in accordance with certain aspects of the present teachings, such as the process described above and shown in FIG. 3. To the extent that the multi-polymer plastic decorative component 350A of FIGS. 7A-7B shares features with the component 350 in FIGS. 6A-6B, the reference numerals will not be reintroduced for brevity. The multi-polymer plastic decorative component 350A also has a second polymer 358A that defines at least one colored surface region 360A (designated by “x” in FIG. 6B) of surface 356A, where the colored polymer 358A is resistant to metallization (and further is preferably substantially free of metal-plating). The colored polymer 358A has a surface paint coating 382 applied thereon to form colored polymer surface region 360A.

The metallized surface region 354 may be seen from a viewing perspective (designated by “y” regions) in the surrounding external environment 362 adjacent to the colored surface region 360A (“x” regions). Together, the first metal-platable polymer 352 and the surface coating 382 (disposed over the second polymer 358A) define the surface 356A of the component that can be viewed from the surrounding environment 362. As shown in the present embodiment, the first metal-platable polymer 352 and the surface coating 382 are substantially flush with one another to form surface 356A. As appreciated by those of skill in the art, such an embodiment is exemplary, because the first metal-platable polymer 352 and second polymer 358A can be multi-shot injected to form any number of different configurations. Likewise, any combination of surface coatings 382 may be applied over select regions of the second polymer 358A, thus forming any number of designs by respective locations of metallized surface 354 and colored surface region 360A.

In various aspects, suitable polymers for forming the metal platable first polymer include: acrylonitrile-butadiene-styrene (ABS), polycarbonate (PC), acrylonitrile-butadiene-styrene/polycarbonate (ABS/PC), copolymers, equivalents, and combinations thereof. In certain preferred aspects, the first metal-platable polymer comprises acrylonitrile-butadiene-styrene (ABS). Suitable examples of such polymers include those commercially available as CYCOLAC™ MG37EPX-GY4A087, MC1300-GY6026, and MG37EP-GY4A087, which are ABS and ABS-PC copolymers commercially available from SABIC Innovative Plastics. Another suitable polycarbonate polymer is commercially available as TERLURAN™ BX 13074 from BASF, Corp.

In various aspects, suitable polymers for forming the second polymer include: an acrylic polymer, a methacrylic polymer, an acrylic copolymer, a methacrylic copolymer, and combinations thereof. One particularly suitable commercially available second polymer is a colored acrylic copolymer PLEXIGLAS™ V825 UVA acrylic resin sold by Arkema, Inc. which is a proprietary copolymer of ethyl acrylate and methyl methacrylate having UV resistance, a melt flow rate (MFR) of 3.7 g/10 minutes at 230° C., a specific gravity of 1.19, a tensile strength of 10,200 psi and an tensile elongation at break of 6%.

In certain alternative embodiments, at least one of the polymeric compositions can contain a reinforcement material. The reinforcement material may include clays, fillers or fibers or the like, which may be used in combination with one another. For example, suitable fibers can include carbon fibers, glass fibers, and combinations thereof.

In certain variations, the second polymer is colored and resistant to metallization. Certain second polymers may be selected to be stable to UV radiation or alternatively can have a UV stable topcoat applied thereon. For example, if the second polymer comprises a colored polycarbonate (which is typically not UV stable), a UV radiation resistant topcoat is applied over the exposed regions of polycarbonate. In other aspects, the second polymer may have a colored surface coating, such as a paint applied thereon to form one or more colored surface regions.

In certain aspects, the second polymer or the surface coating may comprise one or more colorants (pigments, dyes, particles) to provide the desired color for the polymer. Suitable colorants include, but are not limited to, dyes and pigments. A pigment is generally an inorganic or organic, colored, white or black material that is usually substantially insoluble in solvents; while a dye, unlike a pigment, is generally soluble in a solvent or carrier. In certain aspects, a preferred colorant for the second polymer or the surface coating is a pigment.

Hence, in certain aspects of the present teachings, the second polymer is resistant to metallization, but has a surface coating paint applied thereto to form the colored surface finish. Suitable paints for the surface coatings include conventional automotive and exterior paints, which are compatible with the underlying second polymer. In certain variations, a primer layer, undercoat, or another conventional coating may be used to enhance adhesion of the paint to the second polymer. In certain aspects, a suitable paint is ultraviolet radiation stable and does not require a further topcoat. Suitable paints are optionally cross-linked after being applied to the surface of the second polymer. The present teachings also contemplate application of one or more protective topcoats or clear coats over the paint where necessary (especially in embodiments where the paint is not ultraviolet-radiation resistant).

Exemplary automotive and exterior paints include one or more film-formers (e.g., resins) and one or more colorants, like solid pigments or dyes, along with conventional paint additives, such as UV protectants, extenders, coalescing agents, polymerization catalysts for curable compositions, or rheology additives and the like. Solvent-based paints with pigment colorants can typically include greater than or equal to about 40% to less than or equal to about 60% by weight pigment, whereas aqueous or water-based paints, typically have a lower pigment content, for example greater than or equal to about 20% to less than or equal to about 35% by weight pigment. The film formers may be suitably selected from solvent or aqueous bases in paint and lacquer formulations known in the art. Particularly suitable film forming resins are selected from those based on acrylic, urethane, polyester, or melamine formaldehyde resins. In certain variations, acrylic resins as the film formers are preferred, such as acrylamide, acrylonitride, methyl acrylate, and/or ethylhexyl acrylate. In other aspects, the second polymer is resistant to metallization and also has a surface coating paint applied thereto to form at least a portion of the colored surface finish.

By way of non-limiting example, suitable pigment colorants include by way of non-limiting example, pearlescent, iridescent, metallic flake, ultramarine pigments, effect pigments, fluorescent pigments, phosphorescent pigments, inorganic pigments, carbon black pigments, natural pigments, organic pigments, mixed metal oxide pigments, iron oxide pigments, titanium dioxide pigments, organic azo pigments (such as azo lake pigments, insoluble azo pigments, condensed azo pigments, and chelate azo pigments), organic polycyclic pigments (such as phthalocyanine based pigments, anthraquinone based pigments, perylene based pigments, perinone based pigments, indigo based pigments, quinacridone based pigments, dioxazine based pigments, isoindolinone based pigments, quinophthalone based pigments, and diketopyrrolopyrrole (DPP) based pigments), dyeing lake pigments (such as lake pigments of acid or basic dyes), azine pigments; and the like. Further, suitable colorants may include surface-treated pigments.

In certain aspects, suitable protective surface coatings may comprise a transparent polymer (which may be the same polymer as the second polymer, but lacking in colorants). For example, an ultraviolet radiation-stable transparent topcoat may comprise an acrylic polymer, an acrylic copolymer, a methacrylic polymer, a methacrylic copolymer, or combinations thereof. Such a topcoat may further comprise tinting or pigments to provide desired texture or surface effects. One particularly suitable commercially available second polymer is a transparent acrylic copolymer PLEXIGLAS™ V825 UVA acrylic resin sold by Arkema, Inc. which is a proprietary copolymer of ethyl acrylate and methyl methacrylate having UV stability/resistance.

Thus, the present disclosure provides multi-polymer components having at least one metallized region and at least one colored and non-metallized region that are durable and resistant to corrosion and degradation from extreme weather conditions. While not limiting the present disclosure, in preferred variations, the multi-polymer component may be a decorative component for a vehicle such as an automobile, truck, van, motorcycle, snowmobile, jet ski, boat, and the like. Such decorative components include detailing and trim features, indicia of brands, logos, emblems, and the like, as well, as instrument panels and other interior design features. Furthermore, such components may be used in a wide variety of applications and are not limited to use merely in vehicles, but rather may be used in a variety of applications, including in components for consumer goods, domestic and industrial appliances, retail and point-of-sale applications, toys, reflector components, and the like.

The multi-injection molding processes of the present teachings are streamlined and more efficient than traditional methods of forming polymeric components having metallized regions and non-metallized regions, including molded components having relative complex designs. The multi-polymer components formed from these processes are durable, corrosion resistant, and yet have improved aesthetics exhibiting well defined metallized region(s) that are visibly distinct from one or more colored regions.

The present disclosure provides various methods of forming molded metallized polymeric components. In one variation, the method comprises forming a molded component via multi-shot injection molding of a first resin and a second resin, where the first resin forms a first polymer that is metal-platable and the second resin forms a second polymer that is resistant to metallization. In certain embodiments, the first polymer is selected from the group consisting of: acrylonitrile-butadiene-styrene (ABS), acrylonitrile-butadiene-styrene/polycarbonate (ABS/PC), and combinations thereof. In certain embodiments, the second polymer is selected from the group consisting of: a polycarbonate polymer, an acrylic polymer, an acrylic copolymer, a methacrylic polymer, a methacrylic copolymer, and combinations thereof.

One or more regions of a surface of the molded component are then metallized to form one or more metallized regions over the first polymer. As described previously above, the metallizing may further comprise first etching the one or more regions of the first surface followed by at least one plating process selected from the group consisting of: an electroless bath, an electroplating bath, and combinations thereof, to form the one or more metallized regions.

In certain variations, the one or more regions of the surface are etched with an etching solution comprising chromium and sulfuric acid. Then, the one or more regions of the surface to be metallized are treated by an electroless plating process comprising a medium phosphorus electroless nickel bath, followed by a first electroplating process to form at least one copper (Cu) layer, a second electroplating process to form at least one nickel (Ni) layer, and a third electroplating process to form at least one chromium layer (Cr).

A surface coating can be applied to one or more regions defined by the second polymer to define one or more colored surface regions that are visually distinct from the one or more metallized regions. In certain variations, the surface coating is a colored paint applied to one or more regions of the second polymer. In certain embodiments, the paint is an ultraviolet radiation-stable paint. In other variations, applying of the surface coating further comprises applying an ultraviolet radiation-stable transparent topcoat over the applied paint. The ultraviolet radiation-stable transparent topcoat may comprise an acrylic polymer, an acrylic copolymer, a methacrylic polymer, a methacrylic copolymer, or combinations thereof. Thus, by such methods, a molded metallized polymeric component is formed.

In other aspects, the present disclosure provides a molded metallized polymeric component that can be used as a decorative component. In certain variations, one or more metallized surface regions are formed on a first injection-molded polymer that is metal-platable. In certain embodiments, the metallized surface regions of the first layer comprise a chrome-plating.

One or more colored surface regions are likewise formed in regions corresponding to a second injection-molded polymer that is resistant to metallization. In certain aspects, the second injection-molded polymer has a color that defines the one or more colored surface regions. In other aspects, the one or more colored surface regions correspond to a second injection-molded polymer that is painted. The one or more painted colored surface regions optionally comprise an ultraviolet radiation-stable paint.

Further, in certain variations, the one or more colored surface regions optionally further comprises an ultraviolet-radiation stable transparent topcoat. In certain aspects, the ultraviolet radiation-stable transparent topcoat comprises an acrylic polymer, an acrylic copolymer, a methacrylic polymer, a methacrylic copolymer, or combinations thereof. In certain embodiments, the first polymer is selected from the group consisting of: acrylonitrile-butadiene-styrene (ABS), acrylonitrile-butadiene-styrene/polycarbonate (ABS/PC), and combinations thereof. In certain embodiments, the second polymer is selected from the group consisting of: a polycarbonate polymer, an acrylic polymer, an acrylic copolymer, a methacrylic polymer, a methacrylic copolymer, and combinations thereof.

Hence, the first injection-molded polymer and the second injection-molded polymer are integrally formed with one another to form the molded metallized polymeric component. At least a portion of the one or more metallized surface regions and the one or more colored surface regions are visible to an external environment.

The present disclosure provides a decorative molded chrome-plated polymeric component comprising a surface visible to an external environment. In certain variations, the polymeric component comprises one or more chrome-plated regions disposed over an injection-molded metal-platable polymer and one or more colored painted regions disposed over a second injection-molded polymer that is resistant to metallization. The first and second injection-molded polymers are integrally formed during a multi-shot injection process, and the one or more colored painted regions are ultraviolet radiation-stable. In certain aspects, the second injection-molded polymer is colored and defines the one or more colored surface regions that are further painted with an ultraviolet-radiation stable transparent topcoat so as to form the one or more colored painted regions. In other aspects, the second injection-molded polymer is painted with a colored paint, such as a UV-stable paint so as to form the one or more colored painted regions.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of forming a molded metallized polymeric component, comprising:
forming a molded component via multi-shot injection molding of a first resin and a second resin, wherein the first resin forms a first polymer that is metal-platable and the second resin forms a second polymer that is resistant to metallization;
metallizing one or more regions of a surface of the molded component to form one or more metallized regions over the first polymer; and
applying a surface coating to one or more regions defined by the second polymer to create one or more colored surface regions that are visually distinct from the one or more metallized regions, thereby forming the molded metallized polymeric component.

2. The method of claim 1, wherein the surface coating is a colored paint applied to one or more regions of the second polymer to form the one or more colored regions after the metallizing.

3. The method of claim 1, wherein the metallizing further comprises first etching the one or more regions of the surface followed by at least one plating process selected from the group consisting of: an electroless bath, an electroplating bath, and combinations thereof, to form the one or more metallized regions.

4. The method of claim 3, wherein the one or more regions of the surface are etched with an etching solution comprising chromium and sulfuric acid, followed by an electroless plating process comprising a medium phosphorus electroless nickel bath, followed by a first electroplating process to form at least one copper (Cu) layer, a second electroplating process to form at least one nickel (Ni) layer, and a third electroplating process to form at least one chromium layer (Cr).

5. The method of claim 1, wherein the first polymer and the second polymer are integrally formed with one another in the multi-shot injection molding.

6. The method of claim 1, wherein the first polymer is selected from the group consisting of: acrylonitrile-butadiene-styrene (ABS), acrylonitrile-butadiene-styrene/polycarbonate (ABS/PC), and combinations thereof and the second polymer is selected from the group consisting of: a polycarbonate polymer, an acrylic polymer, an acrylic copolymer, a methacrylic polymer, a methacrylic copolymer, and combinations thereof.

7. The method of claim 1, wherein the surface coating comprises a paint comprising a component selected from the group consisting of: an acrylic resin, a urethane resin, a polyester resin, a melamine formaldehyde resin, and combinations thereof.

8. The method of claim 7, wherein the surface coating comprises an acrylic paint comprising a component selected from the group consisting of: acrylamide, acrylonitride, methyl acrylate, ethylhexyl acrylate acrylics, and combinations thereof.

9. The method of claim 1, wherein the surface coating comprises an ultraviolet radiation-stable paint.

10. The method of claim 9, wherein the ultraviolet radiation-stable transparent topcoat comprises a polymer selected from the group consisting of: an acrylic polymer, an acrylic copolymer, a methacrylic polymer, a methacrylic copolymer, and combinations thereof.

11. The method of claim 1, wherein the applying of the surface coating comprises first applying a paint to the one or more regions defined by the second polymer and then applying an ultraviolet radiation-stable transparent topcoat over the paint.

12. A molded metallized polymeric component comprising:
one or more metallized surface regions formed on a first injection-molded polymer that is metal-platable and one or more colored surface regions corresponding to a second injection-molded polymer that is resistant to metallization, wherein the first injection-molded polymer and the second injection-molded polymer are integrally formed with one another and at least a portion of the one or more metallized surface regions and the one or more colored surface regions are visible to an external environment.

13. The molded metallized polymeric component of claim 12, wherein the second injection-molded polymer has a color that defines the one or more colored surface regions, wherein the one or more colored surface regions further comprise an ultraviolet-radiation stable transparent topcoat.

14. The molded metallized polymeric component of claim 12, wherein the one or more colored surface regions corresponding to a second injection-molded polymer are painted.

15. The molded metallized polymeric component of claim 14, wherein the one or more painted colored surface regions comprise an ultraviolet radiation-stable paint.

16. The molded metallized polymeric component of claim 14, wherein the one or more painted colored surface regions comprise a paint and further comprise an ultraviolet radiation-stable transparent topcoat disposed over the paint.

17. The molded metallized polymeric component of claim 16, wherein the ultraviolet radiation-stable transparent topcoat comprises a polymer selected from the group consisting of: an acrylic polymer, an acrylic copolymer, a methacrylic polymer, a methacrylic copolymer, and combinations thereof.

18. The molded metallized polymeric component of claim 12, wherein the first polymer is selected from the group consisting of: acrylonitrile-butadiene-styrene (ABS), acrylonitrile-butadiene-styrene/polycarbonate (ABS/PC), and combinations thereof and the second polymer is selected from the group consisting of: a polycarbonate polymer, an acrylic polymer, an acrylic copolymer, a methacrylic polymer, a methacrylic copolymer, and combinations thereof.

19. The molded metallized polymeric component of claim 12, wherein the one or more metallized surface regions comprise a chrome-plating.

20. A decorative molded chrome-plated polymeric component comprising:
a surface visible to an external environment comprising one or more chrome-plated regions disposed over an injection-molded metal-platable polymer and one or more colored painted regions disposed over a second injection-molded polymer that is resistant to metallization, wherein the first and second injection-molded polymers are integrally formed during a multi-shot injection process, and the one or more colored painted regions are ultraviolet radiation-stable.

21. The decorative molded chrome-plated polymeric component of claim 20, wherein the second injection-molded polymer is colored and defines the one or more colored surface regions that are further painted with an ultraviolet-radiation stable transparent topcoat so as to form the one or more colored painted regions.

22. The decorative molded chrome-plated polymeric component of claim 20, wherein the second injection-molded polymer is painted with a colored paint so as to form the one or more colored painted regions.

23. The decorative molded chrome-plated polymeric component of claim 20, wherein the first polymer is selected from the group consisting of: acrylonitrile-butadiene-styrene (ABS), acrylonitrile-butadiene-styrene/polycarbonate (ABS/PC), and combinations thereof and the second polymer is selected from the group consisting of: a polycarbonate polymer, an acrylic polymer, an acrylic copolymer, a methacrylic polymer, a methacrylic copolymer, and combinations thereof.

24. The decorative molded chrome-plated polymeric component of claim 20, wherein the one or more chrome-plated regions have a chrome finish formed by etching followed by at least one electroless deposition process, electroplating process, or combinations of electroless deposition and electroplating processes.
